(19) United States
(12) Patent Application Publication
(10) Pub. No.: US 2016/0211547 A1
(43) Pub. Date: Jul. 21, 2016

(54) Hybrid Rechargeable Battery

(71) Applicant: Google Inc., Mountain View, CA (US)

(72) Inventors: Tai Sup Hwang, Santa Clara, CA (US); Ramesh C. Bhardwaj, Fremont, CA (US); Sheba Devan, Santa Clara, CA (US)

(21) Appl. No.: 14/597,858

(22) Filed: Jan. 15, 2015

(51) Int. Cl. H01M 10/0565; H01M 4/134; H01M 10/0525; H01M 4/525; H01M 4/587; H01M 4/131; H01M 4/133

(52) U.S. Cl. CPC H01M 10/0565; H01M 4/131; H01M 4/134; H01M 4/133; H01M 4/525; H01M 4/587; H01M 10/0525; H01M 2300/0085; H01M 2300/0082

(57) ABSTRACT

The present disclosure relates to a battery incorporating a hybrid gel/solid electrolyte. In an example embodiment, a battery may include a copper anode current collector, a lithium metal anode, a lithium phosphorous oxynitride (LiPON) anode protector, an electrolyte, a lithium cobalt oxide (LiCoO2) cathode, and an aluminum cathode current collector. The electrolyte may include a gel electrolyte, a solid electrolyte, and a separator. The separator includes an insulating material layer disposed between a first gel electrolyte layer and a second gel electrolyte layer. In some embodiments, the insulating material may include polyethylene and the gel electrolyte layer may include a liquid and a polymer. Alternatively or additionally, the solid material may include a filler material, which may include silica and a polymer.

### BACKGROUND

Conventional Li-ion batteries include a liquid electrolyte and provide a cost-effective way to produce medium to large (greater than 3 mm cross-section) battery cells. Conventional Li-ion batteries can be manufactured in a high-volume roll-to-roll process.

Solid state Li batteries have emerged as a possible alternative to conventional lithium-ion batteries. In some cases, solid state batteries may have similar voltage and current characteristics as their conventional counterparts, but with improved energy density and reduced bulk and weight.

Accordingly, a need exists for technologies that offer the advantages of both conventional Li-ion and solid state Li batteries. Such technologies may be important as the number of mobile computing devices and implantable medical devices continues to grow.

### SUMMARY

In an example embodiment, a battery may include an electrolyte layer that includes a gel electrolyte and a solid material. For example, an anode current collector layer may be formed on a substrate. An anode layer may be formed on the anode current collector layer. An electrolyte layer having a gel electrolyte and a solid material may be formed on the anode layer. Further, a cathode layer may be formed on the electrolyte layer, and a cathode current collector may be formed on the cathode layer. By forming the battery in such a manner, various characteristics of the battery may be improved. For example, a hybrid electrolyte formed from a solid and a gel may help to address issues such as pinholes and interfacial resistance, which may occur when only solid electrolyte materials are utilized. Other benefits of an example battery structure, such as reduced production costs, may also be possible. Of course, it should be understood that such benefits are not required.

In a first aspect, a battery is provided. The battery includes an anode current collector, an anode, an electrolyte, a cathode, and a cathode current collector. The anode is disposed on the anode current collector. The electrolyte includes a gel electrolyte and a solid material and the electrolyte is disposed on the anode. The cathode is disposed on the electrolyte. The cathode current collector is disposed on the cathode.

In a second aspect, a method is provided. The method includes forming an anode current collector layer on a substrate and forming an anode layer on the anode current collector layer. The method further includes forming an electrolyte layer on the anode layer. The electrolyte layer includes a gel electrolyte and a solid material. The method also includes forming a cathode layer on the electrolyte layer and forming a cathode current collector layer on the cathode.

In a third aspect, a battery is provided. The battery includes an anode current collector disposed on a substrate. The anode current collector includes copper (Cu). The battery also includes an anode, which is disposed on the anode current collector. The anode includes lithium metal (Li). The battery further includes an anode protector, which is disposed on the anode. The anode protector includes lithium phosphorous oxynitride (LiPON). The battery yet further includes an electrolyte, which includes a gel electrolyte, a solid electrolyte, and a separator. The electrolyte is disposed on the anode protector. The separator includes an insulating material layer disposed between a first gel electrolyte layer and a second gel electrolyte layer. The separator is disposed on the solid electrolyte. The battery additionally includes a cathode, which is disposed on the electrolyte. The cathode includes lithium cobalt oxide (LiCoO₂). The battery also includes a cathode current collector, which is disposed on the cathode. The cathode current collector includes aluminum (Al).

Other aspects, embodiments, and implementations will become apparent to those of ordinary skill in the art by reading the following detailed description, with reference where appropriate to the accompanying drawings.

### BRIEF DESCRIPTION OF THE FIGURES

FIG. 1 illustrates a cross-sectional view of a battery, according to an example embodiment.

FIG. 2 illustrates a cross-sectional view of a battery, according to an example embodiment.

FIG. 3 illustrates a cross-sectional view of a battery, according to an example embodiment.

FIG. 4 illustrates a method of forming a battery, according to an example embodiment.

### DETAILED DESCRIPTION

### I. Overview

Conventional Li-ion batteries offer limited volumetric energy (500-600 Wh/L). Furthermore, technological improvement in conventional Li-ion battery performance has been incremental and limited to only 3-5% improvement per year.

Solid state Li batteries may have high production costs due to multiple vacuum deposition and annealing processes. Furthermore, such batteries may have poor long term performance (e.g., a lesser number of acceptable re-charging cycles), at least in part due to pinholes in the solid electrolyte. Also, solid state Li batteries can exhibit higher cell impedance due to increased interfacial resistance of the solid electrolyte.

Pinhole defects may be formed in solid electrolyte materials at the time of layer deposition. For example, when deposited, Li-sulfide glass may include imperfections, such as pinholes. Additionally or alternatively, pinholes may develop or evolve over time within the solid electrolyte layer. Such pinhole defects may lead to battery failure or degraded performance. Example embodiments may provide a separator, which may reduce the effect of pinholes by, for example, preventing short circuit or open circuit conditions.

In solid state batteries, cell impedance may vary based on, for example, the quality of the interface between two or more battery layers. Namely, interfacial resistance may vary depending on the quality of material deposition, among other fabrication variables. By utilizing a gel electrolyte as described herein, the interfacial resistance between the electrolyte and the cathode layer may be lowered and/or be more consistent due to, for example, better electrical contact between the two layers.

Cost may be a substantial consideration when developing processes to mass-produce solid state batteries. Some of the example embodiments described herein may provide reduce production costs because the manufacturing process may include fewer (or zero) vacuum deposition and/or annealing steps as compared to conventional solid state battery processes. For example, some cathode materials described herein may not require a high-temperature annealing treatment. Further, some of the described material layers may be deposited with a fast vacuum process instead of other, more costly, deposition methods. Additionally, some of the fabrication processes described herein may be amenable to roll-to-roll production techniques, which may further drive costs down while offering larger area/volume batteries.

Accordingly, by combining a solid material with a gel electrolyte, hybrid solid state batteries may provide improvements such as reducing the effects of pinholes, lowering interface resistance, and providing a lower-cost manufacturing process. Other advantages will be evident to those of skill in the art.

Example embodiments may relate to or take the form of a hybrid gel/solid electrolyte battery. In some examples, a battery may include an anode current collector, an anode, an electrolyte, a cathode, and a cathode current collector. The electrolyte may include a gel electrolyte and a solid material. In an example embodiment, the battery may optionally include a solid electrolyte and a separator. The separator may include an insulating material disposed between a first gel electrolyte layer and a second gel electrolyte layer. The separator is disposed on the second electrolyte.

Another example embodiment includes a copper anode current collector, a lithium metal anode, a lithium phosphorous oxynitride (LiPON) anode protector, an electrolyte, a lithium cobalt oxide (LiCoO2) cathode, and an aluminum cathode current collector. The electrolyte may include a gel electrolyte, a solid electrolyte, and a separator. The separator includes an insulating material layer disposed between a first gel electrolyte layer and a second gel electrolyte layer.

In some embodiments, the insulating material may include polyethylene and the gel electrolyte layer may include a liquid and a polymer. Alternatively or additionally, the solid material may include a filler material, which may include silica and a polymer.

The battery may include cathode materials such as LiCoO₂, lithium manganese oxide (LMO), lithium iron phosphate (LiFePO₄, LFP), or lithium nickel manganese cobalt oxide (LiNiₓMn_{y}Co_{z}O₂, or NMC). Other cathode materials are possible. Furthermore, the cathode may be coated with aluminum oxide and/or another ceramic material, which may allow the battery to operate at higher voltages and/or provide other performance advantages.

The cathode materials may be deposited in various ways, including pulsed laser deposition (PLD), magnetron sputtering, physical vapor deposition (PVD) and chemical vapor deposition (CVD).

Anode materials of the battery may include lithium metal. Additionally or alternatively, the anode may include lithium titanate (Li₄Ti₅O₁₂). Li-free anode materials such as graphite, carbon, silicon, or other solid state battery anode materials are possible.

Cathode and anode current collectors of batteries disclosed herein may include a conductive and/or low-resistance material, such a metal. Furthermore, the cathode current collector and the anode current collector may be configured to block lithium ions and various oxidation products (e.g. water, oxygen, nitrogen, etc.). In other words, the cathode current collector and the anode current collector may include materials that have lower (and preferably minimal) reactivity with lithium as compared to some conventional conductive materials. For example, the cathode current collector and the anode current collector may include one or more of: gold (Au), silver (Ag), aluminum (Al), copper (Cu), cobalt (Co), nickel (Ni), palladium (Pd), zinc (Zn), and platinum (Pt). Alloys of such materials are also contemplated herein.

In some embodiments, an adhesion layer material, such as Ti may be utilized. In other words, the current collectors may include multiple layers, e.g. titanium, platinum, and gold (TiPtAu). Other materials are possible to form the cathode current collector and the anode current collector. Alternatively or additionally, current collectors may include graphene, carbon nanotubes, silver nanowires, or other materials.

Example embodiments include an electrolyte, which may allow and/or regulate ion conduction between the cathode and anode. Electrolytes considered herein may include a solid material and a gel electrolyte material.

The gel electrolyte material may generally include a jelly-like material having a three-dimensionally cross-linked system and which may behave like a solid. In an example embodiment, the gel electrolyte may include a dispersion of molecules of a liquid within a solid. In other words, the gel electrolyte may include a continuous phase (solid) and a discontinuous phase (liquid).

The gel electrolyte material may include a covalent polymer network. The covalent polymer network may be formed by cross-linking polymer chains or through another polymerization process. Alternatively or additionally, the gel electrolyte material may be formed by physical aggregation of polymer chains or monomers, for instance in a thermoreversible gel process or a sol-gel process. The gel electrolyte material may include superabsorbent polymers (SAPs), which may be configured to absorb large volumes of liquid relative to their own mass. For example, the gel electrolyte material may include a hydrogel or an aquagel. In such a scenario, the hydrogel may include a colloidal dispersion in water.

The gel electrolyte may include any one of, or a combination of, materials configured to provide binding properties such as polyvinyl alcohol (PVA), polyethylene oxide (PEO), polyvinylidene fluoride (PVDF), polymethylmethacrylate (PMMA), polyimide (PI), or polyacrylamide (PAA). Alternatively, the electrolyte may include a different type of gel like hydrolyzed collagen (e.g. gelatin) or polysaccharide agarose (agar). Other binder and gel materials are possible within the scope of the present disclosure.

Additionally, the gel electrolyte may include materials configured to facilitate ion conduction between the cathode and anode. For example, the gel electrolyte may include a lithium salt, such as lithium hexafluorophosphate (LiPF₆), lithium perchlorate (LiClO₄), or lithium tetrafluoroborate (LiBF₄). The gel electrolyte may additionally or alternatively include an organic solvent such as ethylene carbonate, dimethyl carbonate, or diethyl carbonate.

The solid material may include an inorganic solid state electrolyte such as lithium phosphorous oxynitride (LiPON). In some embodiments, the LiPON may be deposited by RF magnetron sputtering or physical vapor deposition. For example, deposition of LiPON may include exposing a target of lithium phosphate to plasma in a nitrogen environment.

Solid state electrolyte materials may additionally or alternatively include lithium sulfide glass (e.g. Li₂-P₂S₅), lithium super ionic conductor (e.g. Li₂₊₂ₓZn₁₋ₓGeO₄, LISICON), and a garnet-type glass (e.g. Li₆BaLa₂Ta₂O₁₂). Such materials may be formed by various deposition techniques such as sputtering and p.

Additionally or alternatively, the solid material may include a solid electrolyte incorporated into a sheet or fiber-wool form. In some embodiments, the solid material may include a xerogel or an aerogel. In such scenarios, a solid may be formed from a gel by drying, in some cases, under supercritical conditions.

In yet other embodiments, the solid material may include a filler material such as silica. For example, the electrolyte may include silica gel. The silica solid may be incorporated into the liquid or gel with a weight fraction of around 10-20%. Other weight fractions of silica to the liquid or gel may be possible. In some embodiments, silica may impart mechanical stability to a liquid or gel system.

The battery materials described above may be formed on a substrate. The substrate may include a variety of materials. For example, the substrate may include one or more of: a silicon wafer, a plastic, a polymer, paper, fabric, glass, or a ceramic material. Other materials of the substrate are contemplated herein. Generally, the substrate may include any solid or flexible material.

In an example embodiment, the aforementioned elements of the battery may be patterned, removed, and/or deposited in a selective manner. That is, the materials need not be deposited in a blanket layer across an entire area of a given substrate. Instead, the respective materials may be deposited and/or formed in selected areas of the substrate in an additive or subtractive fashion. Alternatively, the materials may be deposited in a blanket layer fashion and then selectively removed using various techniques such as photolithography and laser scribing.

In some embodiments, the battery may include an encapsulation. The encapsulation may include a material configured to protect and stabilize the underlying elements of the battery. For example, the encapsulation may include an inert material, an insulating material, a passivating material, and/or a physically- and/or chemically-protective material. In an embodiment, the encapsulation may include a multilayer stack which may include alternating layers of a polymer (e.g. parylene, photoresist, etc.) and a ceramic material (e.g. alumina, silica, etc.) Additionally or alternatively, the encapsulation may include silicon nitride (SiN) and/or other materials.

In an example embodiment, the battery may occur in a stacked arrangement. That is, instances of the battery may be placed on top of one another. The encapsulation may provide a planarization layer for a further substrate and accompanying battery materials. Alternatively, the battery materials may be formed directly on the encapsulation without a further substrate. In such a way, multiple instances of the battery may be formed on top of one another.

### II. Example Batteries

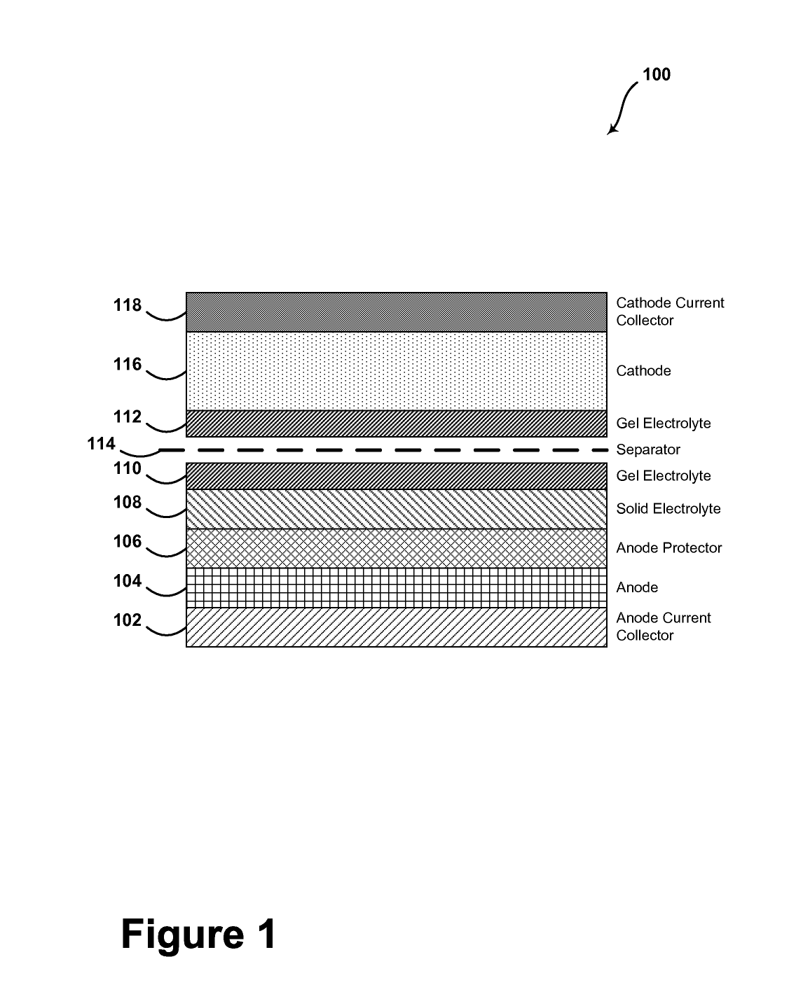

FIG. 1 illustrates a cross-sectional view of a battery 100, according to an example embodiment. The battery 100 may include an anode current collector 102 and an anode 104. The anode current collector 102 may include a metal such as copper. The anode current collector 102 may additionally or alternatively include carbon nanotubes and/or metal nanowires. The anode current collector 102 may include a layer approximately six microns thick, but other thicknesses are possible. The anode 104 may include lithium metal and may include a layer approximately six microns thick. The battery 100 may also include an anode protector 106 disposed on the anode 104. The anode protector 106 may include LIPON in a layer approximately 1.5 microns thick. In an example embodiment, the LiPON material may allow lithium ion transport while preventing a short circuit between the anode 108 and the cathode 104.

The battery 100 includes a layer of solid electrolyte 108, which may be approximately 2 microns thick. The solid electrolyte 108 may include lithium sulfide glass, lithium super ionic conductor, and a garnet-type glass. In an example embodiment, the solid electrolyte 108 may be porous and/or include pinholes. Other solid electrolyte materials configured to facilitate lithium ion transport are possible.

The battery 100 includes a separator 114 with a first gel electrolyte layer 110 and a second gel electrolyte layer 112 disposed on either side of the separator 114. The separator 114 with the gel electrolyte layers 110 and 112 are disposed on the solid electrolyte 108. The gel electrolyte 110 and 112 may include a liquid and a polymer. The gel electrolyte 110 and 112 may alternatively or additionally include any of the gel electrolyte materials described elsewhere herein. The gel electrolyte layers 110 and 112 may each be 1.5 microns thick.

The separator 114 may include polyethylene (PE) and may be 6 microns thick. The separator 114 may be coated on both sides with gel electrolyte layers before the assembly is disposed onto the solid electrolyte 108. The separator 114 and the gel electrolyte layers 110 and 112 may be configured to reduce or eliminate the effect of pinholes in the solid electrolyte 108.

The battery 100 may include a cathode 116 disposed on the gel electrolyte layer 112. The cathode 116 may include LCO or another cathode material disclosed herein. The cathode 116 may be approximately 47 microns thick, however other thicknesses are possible.

The battery 100 may include a cathode current collector 118. The cathode current collector 118 may include aluminum or another conductive material. Furthermore, the cathode current collector 118 may be disposed on the cathode 116.

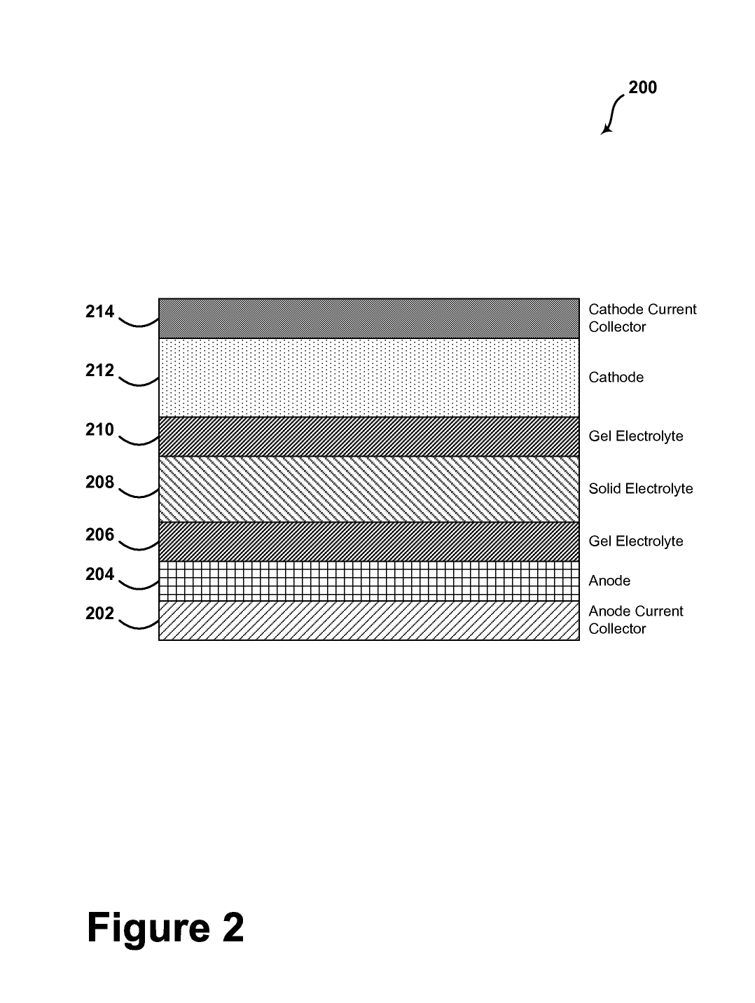

FIG. 2 illustrates a cross-sectional view of a battery 200, according to an example embodiment. Similar to battery 100, battery 200 may include an anode current collector 202, an anode 204, a cathode 212, and a cathode current collector 214. Battery 200 may include a first gel electrolyte layer 206 disposed on the anode 204 and a solid electrolyte 208 disposed on the gel electrolyte 206. Battery 200 may include a second gel electrolyte layer 210 disposed on the solid electrolyte 208. In other words, the solid electrolyte material may be disposed between the first gel electrolyte layer 206 and the second gel electrolyte layer 210.

The solid electrolyte 208 may be 20 microns thick and may include any of the solid electrolyte materials described herein. The first gel electrolyte layer 206 and the second gel electrolyte layer 210 may be approximately 2 microns thick. The first gel electrolyte layer 206 and the second gel electrolyte layer 210 may include any of the gel electrolyte materials described herein. Battery 200 also includes the cathode 212 disposed on the second gel electrolyte layer 210.

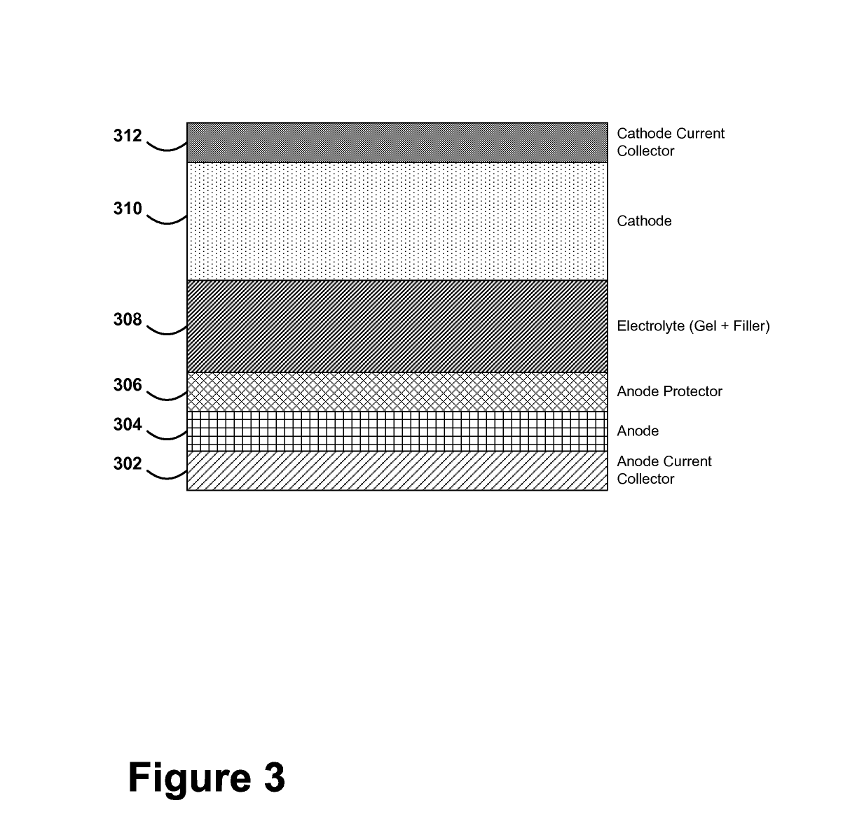

FIG. 3 illustrates a cross-sectional view of a battery 300, according to an example embodiment. The battery 300 includes an anode current collector 302, which may be copper approximately 6 microns thick. The battery 300 also includes an anode 304 that include lithium metal approximately 6 microns thick. The battery 300 additionally includes an anode protector 306 approximately 2 microns thick. The battery 300 may also include an electrolyte 308 approximately 10 microns thick. The electrolyte 308 includes a gel electrolyte and a filler material. The electrolyte 308 may be formed as a gravure coating on the anode protector 306. The battery 300 includes a cathode 310 that may be approximately 47 microns thick. The cathode 310 may include any of the cathode materials disclosed herein. The battery 300 also includes a cathode current collector 312, which may be approximately 12 microns thick.

In an example embodiment, the filler material may include silica or another material described herein.

It should be understood that FIGS. 1-3 illustrate the battery 100, battery 200, and battery 300 in a “single cell” configuration and that other configurations are possible. For example, the batteries herein may be connected in a parallel and/or series configuration with similar or different batteries or circuits. In other words, several instances of the batteries described herein may be connected in series to in an effort to increase the open circuit voltage of the battery, for instance. Similarly, several instances of the batteries may be connected in parallel to increase capacity (amp hours). In other embodiments, a battery may be connected in configurations involving other batteries. In an example embodiment, a plurality of instances of battery 100 may be configured in an array on the substrate. Other arrangements are possible.

### III. Example Methods

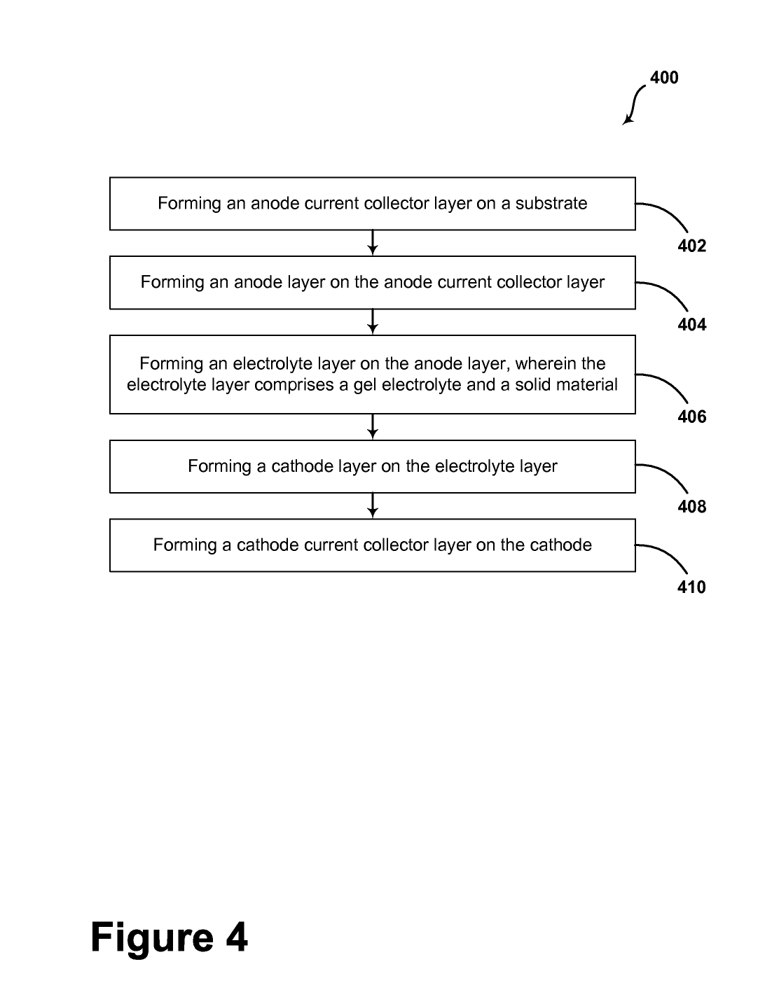

FIG. 4 illustrates a method of forming a battery 400, according to an example embodiment. The method 400 may be carried out to form or compose the elements of batteries 100, 200, and 300 as described and illustrated in FIGS. 1-3. The method may include various blocks or steps. The blocks or steps may be carried out individually or in combination. The blocks or steps may be carried out in any order and/or in series or in parallel. Further, blocks or steps may be omitted or added to method 300.

Block 402 includes forming an anode current collector layer on a substrate. The anode current collector may include a metal, such as copper, and may be 6 microns thick. Other materials and thicknesses are possible.

Block 404 includes forming an anode layer on the anode current collector layer. As described above, the anode may include lithium metal. The lithium metal may be deposited using evaporation, sputtering, or another deposition technique. The anode layer may be deposited as a blanket over the entire substrate and optionally selectively etched or otherwise removed. Alternatively, the anode material may be masked during deposition.

Block 406 includes forming an electrolyte layer on the anode layer. The electrolyte layer includes a gel electrolyte and a solid material. As described above, the gel electrolyte may include a liquid and a polymer. The solid material may include lithium sulfide glass, LISICON, or garnet-type glass.

In an example embodiment, a separator may be optionally formed between two layers of gel electrolyte as described in reference to battery 100.

Block 408 includes forming a cathode layer on the electrolyte layer. In example embodiments, the cathode layer material, such as LCO, may be deposited using RF sputtering or PVD, however other deposition techniques may be used to form the cathode. The deposition of the cathode may occur as a blanket over the entire substrate. A subtractive process of masking and etching may remove cathode material where unwanted. Alternatively, the deposition of the cathode may be masked using a photolithography-defined resist mask. The material of the cathode may be deposited through a shadow mask. The cathode material may be patterned using additive or subtractive fabrication techniques.

Block 410 includes forming a cathode current collector layer on the cathode. The cathode current collector and the anode current collector may be deposited using RF or DC sputtering of source targets. Alternatively, PVD, electron beam-induced deposition or focused ion beam deposition may be utilized to form the cathode current collector and the anode current collector.

In some embodiments, the cathode current collector and the anode current collector may be formed by depositing a blanket material layer on a substrate. The blanket material layer may subsequently be patterned, for example by a masking and etching method or by laser ablation.

An encapsulation layer may be formed over at least the cathode current collector. The encapsulation layer may include an inert and/or passivating material, such as silicon nitride (SiN). In an example embodiment, the encapsulation layer may be about 1 micron thick. The encapsulation layer may include a plurality of layers. The plurality of layers may include at least one of a polymer material and a ceramic material. For example, the encapsulation layer may include a photoresist layer and an alumina layer deposited in an alternating multi-layer fashion.

While some embodiments described herein may include additive deposition techniques (e.g. blanket deposition, shadow-masked deposition, selective deposition, etc.), subtractive patterning techniques are possible. Subtractive patterning may include material removal after deposition onto the substrate or other elements of the battery. In an example embodiment, a blanket deposition of material may be followed by a photolithography process (or other type of lithography technique) to define an etch mask. The etch mask may include photoresist and/or another material such as silicon dioxide (SiO₂) or another suitable masking material.

The subtractive patterning process may include an etching process. The etch process may utilize physical and/or chemical etching of the battery materials. Possible etching techniques may include reactive ion etching, wet chemical etching, laser scribing, electron cyclotron resonance (ECR-RIE) etching, or another etching technique.

In some embodiments, material liftoff processes may be used. In such a scenario, a sacrificial mask or liftoff layer may be patterned on the substrate before material deposition. After material deposition, a chemical process may be used to remove the sacrificial liftoff layer and battery materials that may have deposited on the sacrificial liftoff layer. In an example embodiment, a sacrificial liftoff layer may be formed using a negative photoresist with a reentrant profile. That is, the patterned edges of the photoresist may have a cross-sectional profile that curves inwards towards the main volume of photoresist. Materials may be deposited to form, for instance, the anode and cathode current collectors. Thus, material may be directly deposited onto the substrate in areas where there is no photoresist. Additionally, the material may be deposited onto the patterned photoresist. Subsequently, the photoresist may be removed using a chemical, such as acetone. In such a fashion, the current collector material may be “lifted off” from areas where the patterned photoresist had been. Other methods of sacrificial material removal are contemplated herein.

The particular arrangements shown in the Figures should not be viewed as limiting. It should be understood that other embodiments may include more or less of each element shown in a given Figure. Further, some of the illustrated elements may be combined or omitted. Yet further, an illustrative embodiment may include elements that are not illustrated in the Figures.

While various examples and embodiments have been disclosed, other examples and embodiments will be apparent to those skilled in the art. The various disclosed examples and embodiments are for purposes of illustration and are not intended to be limiting, with the true scope and spirit being indicated by the following claims.

What is claimed is:

1. A battery comprising:
an anode current collector;
an anode, wherein the anode is disposed on the anode current collector;
an electrolyte comprising a gel electrolyte and a solid material, wherein the electrolyte is disposed on the anode;
a cathode, wherein the cathode is disposed on the electrolyte; and
a cathode current collector, wherein the cathode current collector is disposed on the cathode.

2. The battery of claim 1 wherein the electrolyte comprises a solid electrolyte and a separator, wherein the separator comprises an insulating material layer disposed between a first gel electrolyte layer and a second gel electrolyte layer, and wherein the separator is disposed on the solid electrolyte.

3. The battery of claim 2 wherein the insulating material layer comprises polyethylene and wherein the first gel electrolyte layer and the second gel electrolyte layer comprise a liquid and a polymer.

4. The battery of claim 3 wherein the separator is formed by coating a first side of the insulating material layer with the first gel electrolyte layer and coating a second side of the insulating material layer with the second gel electrolyte layer before the electrolyte is disposed onto the solid electrolyte.

5. The battery of claim 1 wherein the solid electrolyte comprises at least one of Li-Sulfide-Glass, Li₂₊₂ₓZn₁₋ₓGeO₄ (LISICON), and a garnet-type solid electrolyte.

6. The battery of claim 1 wherein the cathode comprises lithium cobalt oxide (LiCoO₂), wherein anode comprises lithium metal (Li) and lithium phosphorous oxynitride (LiPON), and wherein the LiPON is disposed between the Li and the electrolyte.

7. The battery of claim 1 wherein the cathode comprises a lithium cobalt oxide (LiCoO₂) and wherein anode comprises lithium metal (Li).

8. The battery of claim 1 wherein the solid material comprises a solid electrolyte material and wherein the electrolyte comprises the solid electrolyte material disposed between a first gel electrolyte layer and a second gel electrolyte layer.

9. The battery of claim 1 wherein the solid material comprises a filler material and wherein the electrolyte comprises at least a composition of the gel electrolyte and the filler material.

10. The battery of claim 9 wherein the filler material comprises silica.

11. The battery of claim 1 wherein the anode current collector is disposed on a substrate, and wherein the anode current collector and the cathode current collector comprise at least one of a metal, carbon nanotubes, and metal nanowires.

12. A method comprising:
forming an anode current collector layer on a substrate;
forming an anode layer on the anode current collector layer;
forming an electrolyte layer on the anode layer, wherein the electrolyte layer comprises a gel electrolyte and a solid material;
forming a cathode layer on the electrolyte layer; and
forming a cathode current collector layer on the cathode.

13. The method of claim 12 wherein the electrolyte layer comprises a solid electrolyte and a separator, wherein the separator comprises an insulating material layer disposed between a first gel electrolyte layer and a second gel electrolyte layer, wherein the separator is disposed on the solid electrolyte, and wherein the solid electrolyte is disposed on the anode layer.

14. The method of claim 13 wherein the insulating material layer comprises polyethylene and wherein the gel electrolyte layer comprises a liquid and a polymer.

15. The method of claim 12 wherein the electrolyte layer comprises at least one of Li-Sulfide-Glass, Li₂₊₂ₓZn₁₋ₓGeO₄ (LISICON), and a garnet-type solid electrolyte.

16. The method of claim 12 wherein the cathode comprises a lithium cobalt oxide (LiCoO₂), wherein anode comprises lithium metal (Li) and lithium phosphorous oxynitride (LiPON), and wherein the LiPON is disposed between the Li and the electrolyte.

17. The method of claim 12 wherein the solid material comprises a solid electrolyte material and wherein the electrolyte comprises the solid electrolyte material disposed between a first gel electrolyte layer and a second gel electrolyte layer.

18. The method of claim 12 wherein the solid material comprises a filler material, wherein the electrolyte comprises at least a composition of the gel electrolyte and the filler material, wherein the filler material comprises silica, wherein the composition is disposed on the anode, and wherein the composition is disposed on the anode by a rotogravure process.

19. A battery comprising:
an anode current collector disposed on a substrate, wherein the anode current collector comprises copper (Cu);
an anode, wherein the anode is disposed on the anode current collector, and wherein the anode comprises lithium metal (Li);
an anode protector, wherein the anode protector is disposed on the anode, and wherein the anode protector comprises lithium phosphorous oxynitride (LiPON);
an electrolyte comprising a gel electrolyte, a solid electrolyte, and a separator, wherein the electrolyte is disposed on the anode protector, wherein the separator comprises an insulating material layer disposed between a first gel electrolyte layer and a second gel electrolyte layer, and wherein the separator is disposed on the solid electrolyte;
a cathode, wherein the cathode is disposed on the electrolyte, wherein the cathode comprises lithium cobalt oxide (LiCoO₂); and
a cathode current collector, wherein the cathode current collector is disposed on the cathode, and wherein the cathode current collector comprises aluminum (Al).

20. The battery of claim 19, wherein the insulating material layer comprises polyethylene and wherein the gel electrolyte layer comprises a liquid and a polymer.
